(19) United States
(12) Patent Application Publication
(10) Pub. No.: US 2016/0182421 A1
(43) Pub. Date: Jun. 23, 2016

(54) POLICY-BASED DELAYED DISPATCH OF E-MAIL MESSAGES

(71) Applicant: International Business Machines Corporation, Armonk, NY (US)

(72) Inventors: Alexander D. S. Mirski-Fitton, Winchester (GB); Edwin P. J. Moffatt, Winchester (GB); Ross B. Pavitt, Headley (GB)

(21) Appl. No.: 14/575,029

(22) Filed: Dec. 18, 2014

(51) Int. Cl. H04L 12/58

(52) U.S. Cl. CPC H04L 51/14; H04L 51/18

(57) ABSTRACT

Software that uses machine logic based algorithms to send e-mail messages according to an e-mail delivery schedule by performing the following steps: (i) receiving, from a sender, a first e-mail message that includes a plurality of recipients intended by the sender to receive the e-mail message, including at least a first recipient and a second recipient; (ii) delivering the first e-mail message to the first recipient; (iii) scheduling a delivery time for delivery of the first e-mail message to the second recipient; (iv) on condition that the first recipient cancels the scheduled delivery prior to the delivery time, cancelling the scheduled delivery of the first-e-mail message to the second recipient; and (v) on condition that the first recipient does not cancel the scheduled delivery prior to the delivery time, delivering the first-e-mail message to the second recipient at, or subsequent to, the delivery time.

### BACKGROUND OF THE INVENTION

The present invention relates generally to the field of electronic mail, and more particularly to policy-based delivery of e-mail messages.

Electronic mail (e-mail) is widely known. E-mail is a method of exchanging digital messages from an author to one or more recipients. Typically, e-mail operates across the Internet or other computer networks, where e-mail systems (or servers) accept, forward, deliver, and store e-mail messages (also referred to as “e-mails” or “messages”). In corporate e-mail systems, some e-mail messages may need to be monitored for various reasons. In particular, an organization may wish to monitor messages sent to recipients outside of the organization in order to prevent confidential information from being sent to unauthorized recipients.

E-mail lists are a special use of e-mail that allow for widespread distribution of information to many individuals. In corporate business use, e-mail lists can be used to send e-mails not only to individuals in an organization, but to groups of individuals who represent different levels of the organization's hierarchy. In some e-mail lists, messages must be approved by an approver before they will be sent to the rest of the members in the list.

### SUMMARY

According to an aspect of the present invention, there is a method, computer program product and/or system that performs the following steps (not necessarily in the following order): (i) receiving, from a sender, a first e-mail message that includes a plurality of recipients intended by the sender to receive the e-mail message, including at least a first recipient and a second recipient; (ii) delivering the first e-mail message to the first recipient; (iii) scheduling a delivery time for delivery of the first e-mail message to the second recipient; (iv) on condition that the first recipient cancels the scheduled delivery prior to the delivery time, cancelling the scheduled delivery of the first-e-mail message to the second recipient; and (v) on condition that the first recipient does not cancel the scheduled delivery prior to the delivery time, delivering the first-e-mail message to the second recipient at, or subsequent to, the delivery time.

### BRIEF DESCRIPTION OF THE DRAWINGS

FIG. 1 is a block diagram view of a first embodiment of a system according to the present invention;

FIG. 2A is a flow chart showing a first embodiment method performed, at least in part, by the first embodiment system;

FIG. 2B is a flow chart showing a second embodiment method performed, at least in part, by the first embodiment system;

FIG. 3 is a block diagram showing a machine logic (for example, software) portion of the first embodiment system; and

FIG. 4 is a screenshot view generated by the first embodiment system.

### DETAILED DESCRIPTION

Mistakes in e-mail messages are commonplace amongst both business and personal users of e-mail systems. For example, an e-mail may contain typographical errors or improperly attached files, or may even be accidentally sent to unintended recipients. Embodiments of the present invention use machine logic based algorithms to send e-mail messages according to an e-mail delivery schedule that provides initial recipients (typically, recipients who will be less impacted by the e-mail message's content) the opportunity to cancel delivery of messages to subsequent recipients, thereby reducing the potential impact of possible mistakes in e-mail messages. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

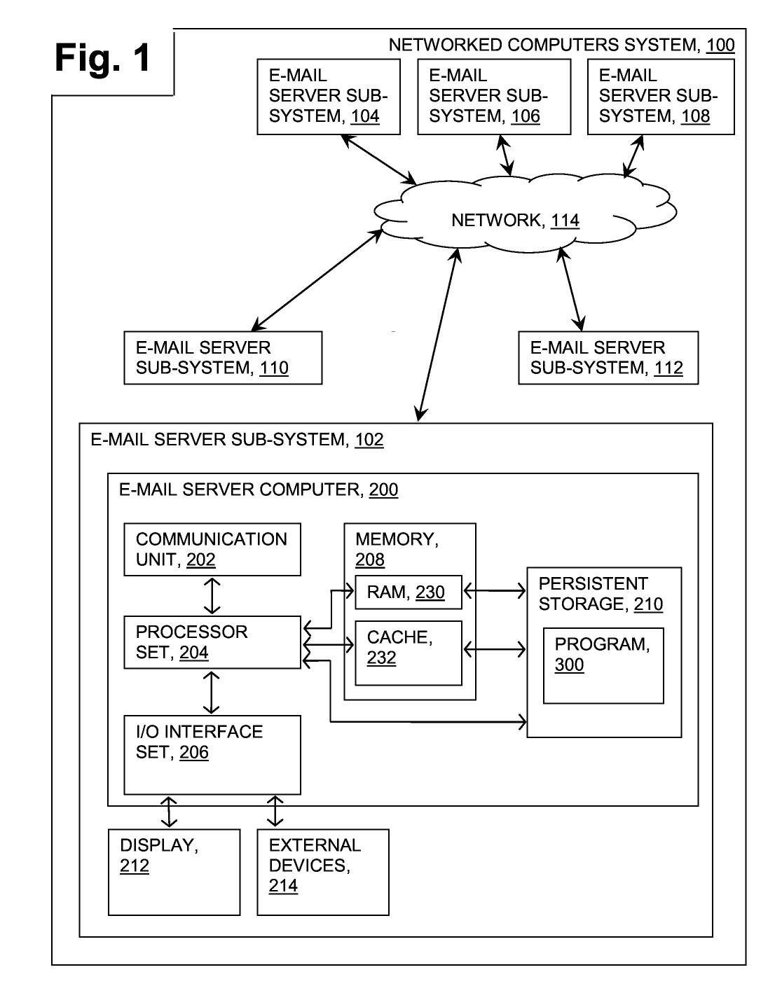

An embodiment of a possible hardware and software environment for software and/or methods according to the present invention will now be described in detail with reference to the Figures. FIG. 1 is a functional block diagram illustrating various portions of networked computers system 100, including: e-mail server sub-system 102; e-mail server sub-systems 104, 106, 108, 110, 112; communication network 114; e-mail server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### II. Example Embodiment

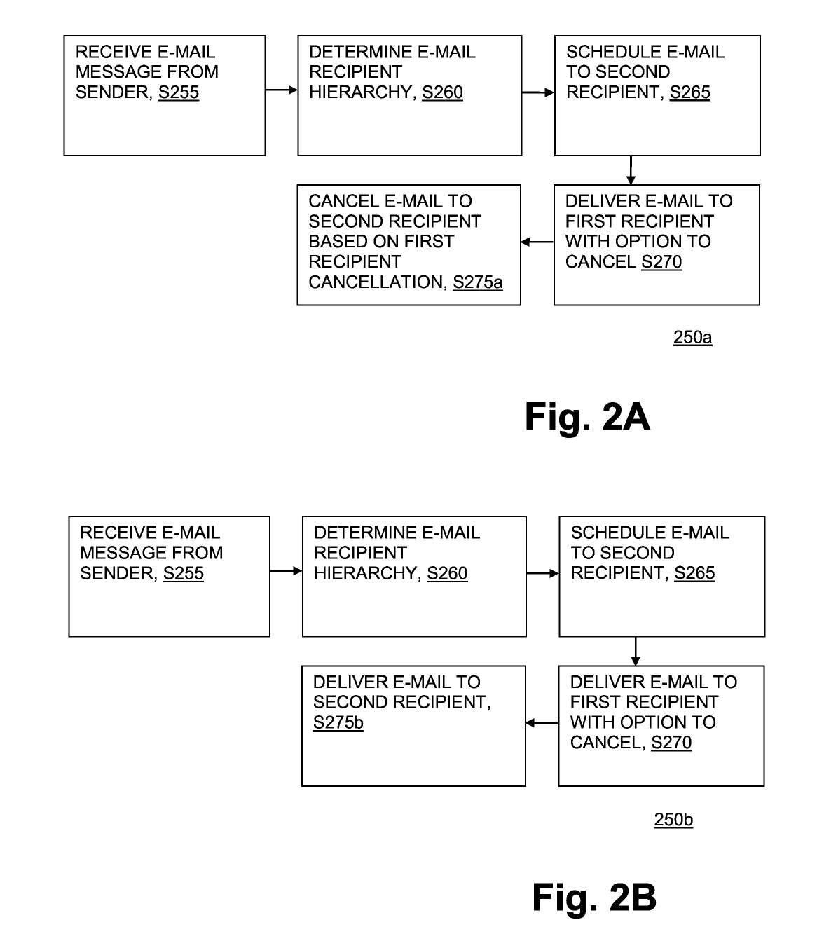

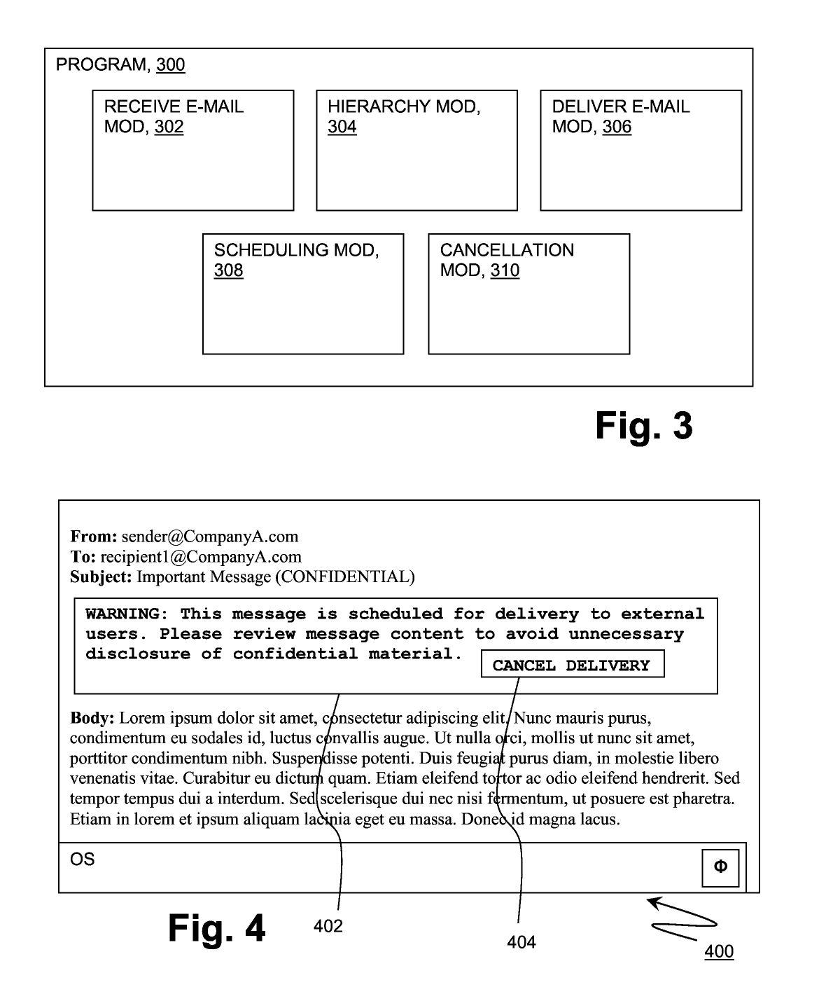

FIG. 2A and FIG. 2B show flowcharts 250a and 250b, respectively, depicting methods according to the present invention. FIG. 3 shows program 300 for performing at least some of the method steps of flowcharts 250a and 250b. These methods and associated software will now be discussed, over the course of the following paragraphs, with extensive reference to FIGS. 2A and 2B (for the method step blocks) and FIG. 3 (for the software blocks).

Processing begins at step S255, where receive e-mail mod 302 receives an e-mail message from a sender. In many embodiments, the e-mail message also includes a plurality of recipients (to be discussed below in relation to other steps of the present method). The e-mail message (also referred to as an “e-mail” or a “message”) may be any known type of electronic mail message, including, for example, an e-mail message utilizing the Multipurpose Internet Mail Extensions (MIME) format. Additionally, the sender may be any user of an e-mail system that is capable of sending e-mail messages, and the recipients may be any users of an e-mail system that are capable of receiving e-mail messages. In the present example embodiment, which will be discussed throughout the following paragraphs, the sender is a computer that automatically generates confidential e-mail messages pertaining to Company A (with an e-mail address at the CompanyA.com domain), and the recipients are: (i) recipient1, who works for Company A (and accordingly has an e-mail address at the CompanyA.com domain); and (ii) recipient2, who does not work for Company A (and accordingly has an e-mail address that is not located at CompanyA.com). An example of an e-mail message according to the present example embodiment is shown in screenshot 400 (see FIG. 4), which will be discussed in more detail below.

Processing continues to step S260, where hierarchy mod 304 (see FIG. 3) determines an e-mail recipient hierarchy (also referred to as the “hierarchy”). Generally speaking, a purpose of the hierarchy is to determine the order in which recipients should receive the e-mail message. For example purposes, the resulting e-mail recipient hierarchy includes two recipients: (i) a first recipient who appears first in the hierarchy (and therefore receives the message first); and (ii) a second recipient who appears second in the hierarchy (and therefore receives the message second). However, this is certainly not meant to be limiting, and embodiments of the present invention will commonly include more than two recipients and/or more than two levels on the hierarchy.

As mentioned above, a recipient may be any user of an e-mail system that is capable of receiving e-mail messages. That is, a recipient is any entity included in the “to:”, “cc:”, and/or “bcc:” fields of an e-mail message header. For example, in some embodiments, recipients include individual persons with individual e-mail accounts. Additionally, in some embodiments, recipients include groups of people and/or groups of e-mail addresses. In fact, in some embodiments, recipients may not be associated with particular persons at all, and may include automated and/or computer controlled e-mail addresses. Furthermore, regardless of whether a particular recipient is a person, a group of people, or a computer, multiple recipients may be placed at the same level in the recipient hierarchy, thereby creating a hierarchy group of recipients who will receive the e-mail message at approximately the same time.

In some embodiments of the present invention, the hierarchy is based, at least in part, on impactibility scores, where impactibility scores typically relate to an estimated amount of impact that the message would have on each respective recipient (or, similarly, an estimated amount of impact that the respective recipient's viewing of the message would have on the sender). In these embodiments, recipients with lower impactibility scores may be placed lower (that is, earlier) in the hierarchy due to their lower chance of being negatively impacted by the e-mail message. In these embodiments, recipients with lower impactibility scores would preferably receive the e-mail message before recipients with higher impactibility scores. For example, in the present example embodiment, the impactibility scores are determined based on whether the recipient is permitted to receive confidential communications pertaining to Company A. In this embodiment, low impactibility scores are given to recipients who work for Company A (as at least some employees of Company A are likely to be permitted to view confidential communications), and high impactibility scores are given to recipients who don't work for Company A (as non-employees of Company A are likely not permitted to view confidential communications). Similarly, in this embodiment, a user with an e-mail address located at the same domain as the sender will typically have a lower impactibility score than a user with an e-mail address located at a different domain than the sender. As such, recipient1 receives a lower impactibility score than recipient2, and the recipient1 is placed lower (that is, earlier) in the hierarchy than recipient2. Therefore, recipient1 (who is the “first recipient” in this example) will receive the e-mail message first, before recipient2 (who is the “second recipient” in this example).

Impactibility scores may be determined in a wide variety of ways. In many embodiments, impactibility relates to a negative impact the message could have on the potential recipient. For example, in some embodiments (such as embodiments discussed below in the Further Comments and/or Embodiments sub-section of this Detailed Description), impactibility may be based, at least in part, on the recipient's estimated reaction to mistakes in the e-mail message (such as, for example, typographical errors). In these embodiments, the recipients who are closest to the sender (and are more likely to help the user correct mistakes before they reach others) may have low impactibility scores. Alternatively, or additionally, recipients who are considered content editors are likely to have a low impactibility score, as their job function may include helping the sender to correct mistakes/errors before they are seen by a larger group of people. Furthermore, “mistakes” may also include non-typographical errors. For example, in some embodiments, a mistake may be an error in selecting the appropriate recipients. In other embodiments, a mistake may include failing to include a required e-mail message attachment, or including the wrong e-mail message attachment.

It should be noted that some embodiments of the present invention (such as those discussed in the Further Comments and/or Embodiments sub-section of this Detailed Description) include impactibility score thresholds. In these embodiments, labels such as “trusted”, “untrusted”, “low”, “medium”, and/or “high” may be used to represent impactibility scores that fall within certain impactibility score thresholds.

Referring still to impactibility scores, in some embodiments, impactibility may not be based solely on an estimated reaction to mistakes in the e-mail message. For example, in some embodiments, impactibility may be related to the potential recipient's sensitivity to the subject matter of the message. For example, recipients may be negatively impacted by an e-mail if it includes offensive content or, for example, includes content that directly affects the recipient's life and/or job status. Additionally, in some embodiments, impactibility may be related to the recipient's general responsiveness to e-mail messages (that is, impactibility may take into account the likelihood that the recipient will immediately read the message as opposed to letting it remain unopened in the recipient's inbox for a period of time). Furthermore, in some embodiments, impactibility may be related to how closely the content of the e-mail message corresponds to the recipient's job role.

Processing proceeds to step S265 (see FIG. 2A), where scheduling mod 308 (see FIG. 3) schedules delivery of the e-mail to the second recipient for a future delivery time. In many embodiments, the purpose of scheduling the e-mail to the second recipient for a future time is to give the first recipient enough time to review the e-mail and cancel the scheduled delivery, if necessary. In the present example embodiment, scheduling mod 308 schedules the e-mail message to be delivered to recipient2 in one hour.

Processing proceeds to step S270 (see FIG. 2A), where deliver e-mail mod 306 delivers the e-mail message to the first recipient, providing the first recipient with the option to cancel the scheduled delivery of the e-mail to the second recipient. An example of the e-mail message along with the corresponding option to cancel is shown in screenshot 400 (see FIG. 4). As shown in FIG. 4, warning box 402 provides the first recipient with a warning message indicating that the message contains confidential information. Specifically, it states: “This message is scheduled for delivery to external users. Please review message content to avoid unnecessary disclosure of confidential material.” Furthermore, button 404 (see FIG. 4) is provided, allowing the user to click button 404 to cancel the scheduled e-mail to the second recipient. In the present example embodiment, recipient1 clicks button 404, and correspondingly triggers the cancellation of the scheduled e-mail.

Processing proceeds to step S275a (see FIG. 2A), where cancellation mod 310 (see FIG. 3), on condition that the first recipient cancels the scheduled delivery to the second recipient prior to the delivery time, cancels the e-mail to the second recipient. In some embodiments (including the present example embodiment), the method completes upon cancellation of the e-mail. However, in other embodiments, additional actions may be taken. For example, in one embodiment, upon canceling the scheduled delivery, program 300 provides the sender with an opportunity to perform a first re-delivery action. In this particular embodiment, if the sender performs the first re-delivery action, program 300 either: (i) re-delivers the message to the first recipient, again providing the option to cancel the subsequent delivery to the second recipient; or (ii) delivers the e-mail message directly to the second recipient, bypassing the first recipient's original cancellation.

Referring now to FIG. 2B, another method according to the present invention is demonstrated by flowchart 250b. In this method, steps S255, S260, S265, and S270 operate identically to their respective counterparts in flowchart 250a. However, step S275b differs from S275a. In FIG. 2B, deliver e-mail mod 306 (see FIG. 3) delivers the e-mail to the second recipient, on condition that the first recipient does not cancel the scheduled delivery prior to the delivery time. Referring to the present example embodiment, in this example, recipient1 chooses not to click on button 404 to cancel the delivery in step S270. Instead, upon reading the e-mail, recipient1 decides that the e-mail message's content is appropriate for recipient2 and therefore takes no action to cancel delivery of the message. As such, when processing proceeds to step S275b, the e-mail is delivered to recipient2.

In some embodiments, program 300 may use machine learning based algorithms to make changes to the recipient hierarchy over time or otherwise alter the subsequent delivery of messages to recipients. In some of these embodiments, program 300 may change the recipient hierarchy based on whether e-mail messages are consistently delivered to a recipient without being canceled by other recipients. Or, in some embodiments, program 300 may change the hierarchy based on an action (such as sending a reply e-mail) taken by a recipient after receiving a message. Or, in other embodiments (including embodiments discussed in the Further Comments and/or Embodiments sub-section of this Detailed Description), program 300 may choose to bypass the delivery schedule altogether. For example, in one embodiment, the e-mail message is successfully delivered to a second recipient, and the second recipient sends a reply message back to the sender. In this example, if the sender then replies to the second recipient, program 300 may, upon determining that the sender's e-mail message is a reply to the second recipient, automatically deliver the e-mail message to the second recipient without a time delay or without providing other recipients with an opportunity to cancel the e-mail message.

It should be noted that in some embodiments of the present invention (including those discussed below in the Further Comments and/or Embodiments sub-section of this Detailed Description), there may be more than two recipients (or hierarchy groups) occupying more than two positions in the e-mail recipient hierarchy. For example, in some embodiments, program 300 schedules a second delivery of the e-mail message to a third recipient. In these embodiments, each of the first recipient and the second recipient are provided with an opportunity to cancel the second delivery, and the e-mail message will be delivered to the third recipient on condition that the first recipient and the second recipient do not cancel the second delivery. This is not meant to be limiting, however, and embodiments of the present invention are adapted to schedule as many deliveries of the e-mail message as may be needed by those using the invention.

### III. Further Comments and/or Embodiments

Some embodiments of the present invention recognize the following facts, potential problems and/or potential areas for improvement with respect to the current state of the art: (i) e-mail users sometimes send external e-mail messages that are not appropriate for external audiences, thereby potentially divulging important information; (ii) existing e-mail systems involve manual processes for approving external e-mails, requiring specific approval; (iii) existing systems significantly slow down the process of getting time-critical information to external parties; and/or (iv) existing policy based e-mail systems only consider blocking access to individuals or groups, and do not allow for a finer control for sending messages.

Embodiments of the present invention include a hierarchical e-mail delivery model combined with a staggered delivery process. In these embodiments, an e-mail composer (also referred to as a “sender”) writes a message once and sends it to all parties. The message delivery is prioritized for parties where mistakes will have the smallest impact first, such as fellow employees, and delivered after short delays to recipients where an inappropriate message may have a larger business impact. If a recipient considers the message inappropriate or in error, the recipient can prevent the message from being sent to remaining parties, thereby avoiding potential business impact.

In many embodiments of the present invention, a system administrator defines an e-mail delivery policy that groups various parties and assigns them a position within an e-mail delivery hierarchy. In one embodiment, for example, e-mail recipients are grouped into three categories: (i) external parties; (ii) management; and (iii) employees. In this embodiment, e-mail messages are delivered first to employees, then to management, and then to external parties. In another embodiment, the groups may further include the following categories: (i) a legal team; and/or (ii) a public relations team, both of which could be prioritized, for example, after employees but before management. Furthermore, many embodiments define specific time lapses between groups. For example, in one embodiment, there is a 10 minute gap between delivery to employees and delivery to managers.

In many embodiments, when a user sends an e-mail message, a server looks at each recipient (in the “to”, “cc”, and “bcc” fields) and schedules the server to send the e-mail message at an allotted time for each recipient (or group of recipients), rather than sending the e-mail messages to everyone at once. In one example: (i) the message is sent to employees immediately; (ii) the message is sent to the legal and public relations teams 10 minutes after the message is sent to employees; (iii) the message is sent to management 30 minutes after the message is sent to the legal and public relations teams; and (iv) the message is sent to external parties 10 minutes after the message is sent to management.

According to many embodiments of the present invention, if, at any point, a recipient (or the sender) of an e-mail message notices an issue with the message's content, the recipient (or sender) can issue a command from his or her e-mail client to halt the message being sent to the next group of people. At this point, the server halts the sending of the message and notifies the composer that the message was halted and informs the composer of any reasons that were provided by the recipient who halted them. The composer can then choose to: (i) continue with sending the message, if the halter is incorrect; (ii) fix/rectify the message and re-send it (beginning again at the first group of recipients); or (iii) prevent the message (or any adjusted message) from being sent.

In some embodiments of the present invention, users (such as senders) are given the ability to further control the delivery of e-mail messages. For example, in one embodiment, a user can specify specific individuals to receive messages first. In this embodiment, the user may want to prioritize team members who often spot issues or people the user works closely with over people who the user has less contact with. In some embodiments, recipients are divided based on shared groupings and/or memberships. For example, prioritization of recipients may be based on a lightweight directory access protocol (LDAP) based system or any other system that electronically defines departments and/or directories. Or, in another example, prioritization is based on social media groupings and/or connections on a social networking service.

In some embodiments of the present invention, additional features are provided to prevent the system from slowing down preferred interactions with external parties. For example, in some embodiments, the staggered send system can be enabled or disabled for specific e-mails. This could be done in a number of ways, including, for example: (i) by including automatic switches that enable/disable the staggered send system under certain conditions (such as enabling the system on the first message in a chain, but ignoring it on subsequent messages in the chain by, for example, looking at whether there is a “re:” at the start of the e-mail message's subject); (ii) by applying rules for certain e-mails (such as, for example, reducing the delay time for each subsequent message in a chain instead of immediately turning it off); and/or (iii) allowing the sender to enable/disable the staggered send system (either via opt-in or opt-out).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

E-mail recipient: any entity included in the “to:”, “cc:”, and/or “bcc:” fields of an e-mail message header.

1-7. (canceled)

8. A computer program product comprising a computer readable storage medium having stored thereon:
first program instructions programmed to receive, from a sender, a first e-mail message that includes a plurality of recipients intended by the sender to receive the e-mail message, including at least a first recipient and a second recipient;
second program instructions programmed to deliver the first e-mail message to the first recipient;
third program instructions programmed to schedule a delivery time for delivery of the first e-mail message to the second recipient;
fourth program instructions programmed to, on condition that the first recipient cancels the scheduled delivery prior to the delivery time, cancel the scheduled delivery of the first-e-mail message to the second recipient; and
fifth program instructions programmed to, on condition that the first recipient does not cancel the scheduled delivery prior to the delivery time, deliver the first-e-mail message to the second recipient at, or subsequent to, the delivery time.

9. The computer program product of claim 8, further comprising:
sixth program instructions programmed to determine the first recipient and the second recipient from the plurality of recipients based, at least in part, on an impactibility score for each recipient, where the impactibility score relates to an estimated amount of impact that the first e-mail message would have on the respective recipient.

10. The computer program product of claim 9, wherein:
the first recipient has a lower impactibility score than the second recipient.

11. The computer program product of claim 10, wherein:
the first recipient's e-mail address is located at the same domain as the sender; and
the second recipient's e-mail address is located at a different domain than the sender.

12. The computer program product of claim 8, further comprising:
sixth program instructions programmed to, upon cancelling the scheduled delivery of the first e-mail message to the second recipient, provide the sender with an opportunity to perform a first re-delivery action; and
seventh program instructions programmed to, on condition that the sender performs the first re-delivery action, deliver the first e-mail message to the second recipient.

13. The computer program product of claim 8, further comprising:
sixth program instructions programmed to schedule a second delivery time for delivery of the first e-mail message to at least a third recipient;
seventh program instructions programmed to, on condition that the first recipient and/or the second recipient cancels the scheduled delivery of the first e-mail message to the third recipient prior to the second delivery time, cancel the scheduled delivery of the first-e-mail message to the third recipient; and
eighth program instructions programmed to, on condition that the first recipient and the second recipient do not cancel the scheduled delivery of the first e-mail message to the third recipient prior to the second delivery time, deliver the first-e-mail message to the third recipient at, or subsequent to, the second delivery time.

14. The computer program product of claim 8, further comprising:
sixth program instructions programmed to determine that the first e-mail message is a reply message to a previous e-mail message sent by the second recipient; and
seventh program instructions programmed to, upon determining that the first e-mail message is a reply message, deliver the first e-mail message to the second recipient at the same time as the first-e-mail message is delivered to the first recipient.

15. A computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to receive, from a sender, a first e-mail message that includes a plurality of recipients intended by the sender to receive the e-mail message, including at least a first recipient and a second recipient;
second program instructions programmed to deliver the first e-mail message to the first recipient;
third program instructions programmed to schedule a delivery time for delivery of the first e-mail message to the second recipient;
fourth program instructions programmed to, on condition that the first recipient cancels the scheduled delivery prior to the delivery time, cancel the scheduled delivery of the first-e-mail message to the second recipient; and
fifth program instructions programmed to, on condition that the first recipient does not cancel the scheduled delivery prior to the delivery time, deliver the first-e-mail message to the second recipient at, or subsequent to, the delivery time.

16. The computer system of claim 15, further comprising:
sixth program instructions programmed to determine the first recipient and the second recipient from the plurality of recipients based, at least in part, on an impactibility score for each recipient, where the impactibility score relates to an estimated amount of impact that the first e-mail message would have on the respective recipient.

17. The computer system of claim 16, wherein:
the first recipient has a lower impactibility score than the second recipient.

18. The computer system of claim 17, wherein:
the first recipient's e-mail address is located at the same domain as the sender; and
the second recipient's e-mail address is located at a different domain than the sender.

19. The computer system of claim 15, further comprising:
sixth program instructions programmed to, upon cancelling the scheduled delivery of the first e-mail message to the second recipient, provide the sender with an opportunity to perform a first re-delivery action; and
seventh program instructions programmed to, on condition that the sender performs the first re-delivery action, deliver the first e-mail message to the second recipient.

20. The computer system of claim 15, further comprising:
sixth program instructions programmed to schedule a second delivery time for delivery of the first e-mail message to at least a third recipient;
seventh program instructions programmed to, on condition that the first recipient and/or the second recipient cancels the scheduled delivery of the first e-mail message to the third recipient prior to the second delivery time, cancel the scheduled delivery of the first-e-mail message to the third recipient; and
eighth program instructions programmed to, on condition that the first recipient and the second recipient do not cancel the scheduled delivery of the first e-mail message to the third recipient prior to the second delivery time, deliver the first-e-mail message to the third recipient at, or subsequent to, the second delivery time.
